(19) United States
(12) Patent Application Publication
(10) Pub. No.: US 2017/0282509 A1
(43) Pub. Date: Oct. 5, 2017

(54) LAMINATED COMPOSITE MATERIAL AND METHOD FOR MAKING THE SAME

(71) Applicant: SAN FANG CHEMICAL INDUSTRY CO., LTD., KAOHSIUNG CITY (TW)

(72) Inventors: CHUNG-CHIH FENG, KAOHSIUNG CITY (TW); KUO-LI LO, KAOHSIUNG CITY (TW); SHENG-HUNG LIAO, KAOHSIUNG CITY (TW); KO-FENG WANG, KAOHSIUNG CITY (TW)

(21) Appl. No.: 15/397,377

(22) Filed: Jan. 3, 2017

(30) Foreign Application Priority Data
Mar. 31, 2016 (TW) 105110379

(51) Int. Cl. B32B 27/12; B32B 27/40; B32B 37/14; B32B 5/02

(52) U.S. Cl. CPC B32B 27/12; B32B 5/024; B32B 27/40; B32B 37/14; B32B 2307/724; B32B 2605/00

(57) ABSTRACT

The present invention relates to a laminated composite material and a method for making the same. The laminated composite material includes a 3D fabric, an adhesion layer, and a resin surface layer. The 3D fabric has a plurality of arranged fibers to form an air permeable structure. The adhesion layer is disposed on a surface of the 3D fabric. The resin surface layer is disposed on the adhesion layer, where the resin surface layer includes at least one layer formed by curing a polyurethane (PU) solution.

### BACKGROUND OF THE INVENTION

### 1. Field of the Invention

The present invention relates to a laminated composite material and a method for making the same, and particularly, to a laminated composite material including a three-dimentional (3D) fabric and a method for making the same.

### 2. Description of the Related Art

A conventional cladding material used for a vehicle seat usually must include a foam material, and a method for making the same is as follows. First, a release paper is provided. Subsequently, a surface layer is coated onto the release paper, and then the surface layer is dried. Then, an adhesion layer is formed on the surface layer. Subsequently, a fabric layer is attached onto the adhesion layer, and usually, the material of the fabric layer is 100% PET. Then, after the release paper is removed, the cladding material can be obtained. However, the cladding material in this stage cannot be directly used to clad a hard seat body, and can be used only after further adhering a foam layer onto the PET fabric layer. Therefore, during actual application, the foam layer is sandwiched between the cladding material and the seat body, so as to provide a cushion, thereby improving comfortableness for a user. However, the foregoing known making method is complex, and there are relatively a lot of layers, resulting in relatively higher manufacturing costs.

Therefore, it is necessary to provide an innovative and progressive laminated composite material and a method for making the same, so as to solve the above problems.

### SUMMARY OF THE INVENTION

The present invention provides a laminated composite material, which comprises a 3D fabric, an adhesion layer and a resin surface layer. The 3D fabric includes a plurality of arranged fibers to form an air permeable structure. The adhesion layer is disposed on a surface of the 3D fabric. The resin surface layer is disposed on the adhesion layer, and the resin surface layer includes at least one layer formed by curing a polyurethane (PU) solution.

The present invention further provides a method for making a laminated composite material, comprising: (a) providing a release paper; (b) forming a resin surface layer on the release paper, where the resin surface layer includes at least one polyurethane (PU) solution; (c) forming an adhesion layer on the resin surface layer; and (d) attaching a 3D fabric to the adhesion layer, wherein the 3D fabric includes a plurality of arranged fibers, so as to form an air permeable structure.

### BRIEF DESCRIPTION OF THE DRAWINGS

The invention will be described according to the appended drawings, in which:

FIG. 1 to FIG. 6 illustrate schematic diagrams of process steps of a method for making a laminated composite material according to an embodiment the present invention.

FIG. 7 illustrates a schematic cross-sectional diagram of a laminated composite material according to an embodiment the present invention.

FIG. 8 illustrates a schematic cross-sectional diagram of a laminated composite material according to an embodiment the present invention.

### PREFERRED EMBODIMENT OF THE PRESENT INVENTION

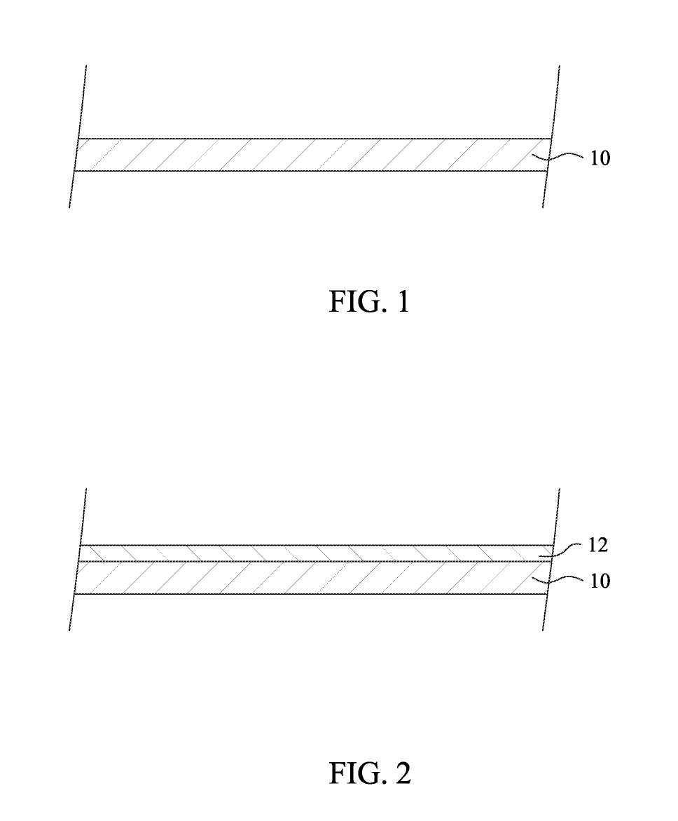

FIG. 1 to FIG. 6 illustrate schematic diagrams of process steps of a method for making a laminated composite material according to an embodiment the present invention. Referring to FIG. 1, a release paper 10 is provided. This illustrated embodiment is a continuous production. Therefore, the release paper 10 is continuously fed/sent.

Subsequently, a resin surface layer 18 (FIG. 4) is formed on the release paper 10, where the resin surface layer 18 includes at least one layer formed by curing a polyurethane (PU) solution. In addition, in this embodiment, the resin surface layer 18 (FIG. 4) is continuously formed, and a forming manner thereof is described as follows.

Referring to FIG. 2, a polycarbonate-polyurethane solution is formed (for example, coated) on the release paper 10. In this embodiment, the solid content of the polycarbonate-polyurethane solution ranges from 10 wt. % to 20 wt. % and preferably, ranges from 12 wt. % to 13 wt. %, and the viscosity thereof ranges from 2000 cps to 3000 cps, and preferably, is 2500 cps. In addition, the polycarbonate-polyurethane solution is continuously formed (for example, coated) on the release paper 10, and an amount of coating thereof is 342.5 g/m². In another embodiment, an antifoamer may be added in advance into the polycarbonate-polyurethane solution, so as to improve a homogeneous status of the polycarbonate-polyurethane solution.

Subsequently, the polycarbonate-polyurethane solution is dried for 90 seconds in an environment of about 100° C., so that the polycarbonate-polyurethane solution is cured to form a first layer 12. In this embodiment, the thickness of the first layer 12 ranges from 0.01 mm to 0.04 mm, and preferably, is 0.025 mm.

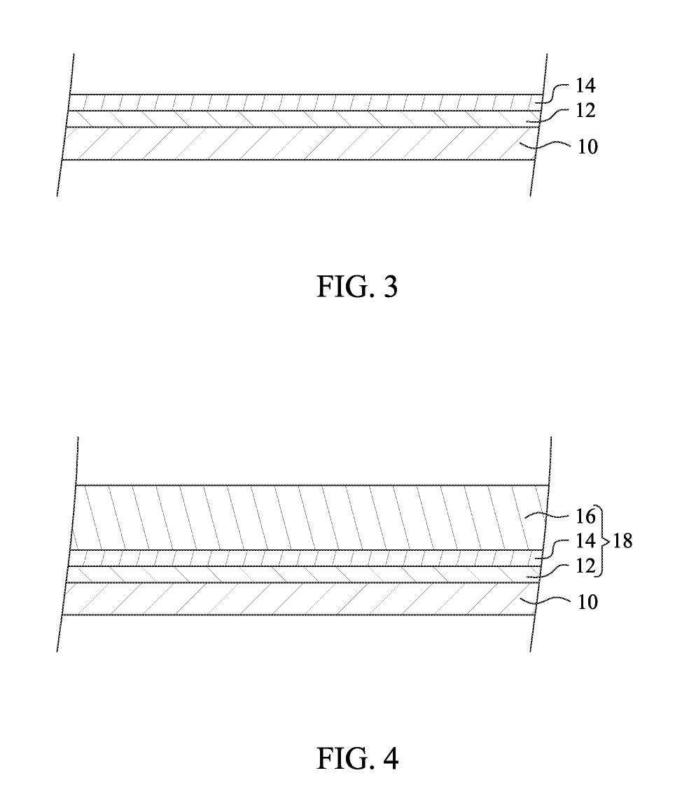

Referring to FIG. 3, a polyether-polyurethane solution is formed (for example, coated) on the first layer 12. In this embodiment, the solid content of the polyether-polyurethane solution ranges from 10 wt. % to 20 wt. % and preferably, ranges from 12 wt. % to 13 wt. %, and the viscosity thereof ranges from 2000 cps to 3000 cps, and preferably, is 2500 cps. In this embodiment, the solid content and viscosity of the polyether-polyurethane solution are equal to those of the polycarbonate-polyurethane solution. However, it could be understood that the solid content and viscosity of the polyether-polyurethane solution may be different from those of the polycarbonate-polyurethane solution.

In addition, the polyether-polyurethane solution is continuously formed (for example, coated) on the first layer 12, and an amount of coating thereof is 205.5 g/m². In this embodiment, the amount of coating of the polyether-polyurethane solution is less than that of the polycarbonate-polyurethane solution.

In another embodiment, an antifoamer may be added in advance into the polyether-polyurethane solution, so as to improve a homogeneous status of the polyether-polyurethane solution.

Subsequently, the polyether-polyurethane solution is dried for 90 seconds in an environment of about 100° C., so that the polyether-polyurethane solution is cured to form a second layer 14. In this embodiment, the thickness of the second layer 14 ranges from 0.01 mm to 0.04 mm, and preferably, is 0.025 mm. In this embodiment, the thickness of the second layer 14 is equal to the thickness of the first layer 12. However, it could be understood that the thickness of the second layer 14 may be different from the thickness of the first layer 12.

Referring to FIG. 4, a polyurethane (PU) solution is formed (for example, coated) on the second layer 14. In this embodiment, the solid content of the PU solution ranges from 80 wt. % to 95 wt. % and preferably, is about 90 wt. %, and the viscosity thereof ranges from 2000 cps to 10000 cps, and preferably, is 6000 cps. In this embodiment, the solid content of the PU solution is 4 to 9.5 times the solid content of the polyether-polyurethane solution.

In addition, the PU solution is continuously formed (for example, coated) on the second layer 14, and an amount of coating thereof is 548.0 g/m². In this embodiment, the amount of coating of the PU solution is greater than that of the polyether-polyurethane solution and that of the polycarbonate-polyurethane solution.

Subsequently, the PU solution is dried for 3 minutes in an environment of about 150° C., so that the PU solution is cured to form a third layer 16. Meanwhile, the first layer 12, the second layer 14 and the third layer 16 form the resin surface layer 18. In this embodiment, the thickness of the third layer 16 ranges from 0.3 mm to 0.5 mm, and preferably, 0.35 mm to 0.4 mm. In this embodiment, the thickness of the third layer 16 is 50 to 13 times the thickness of the second layer 14.

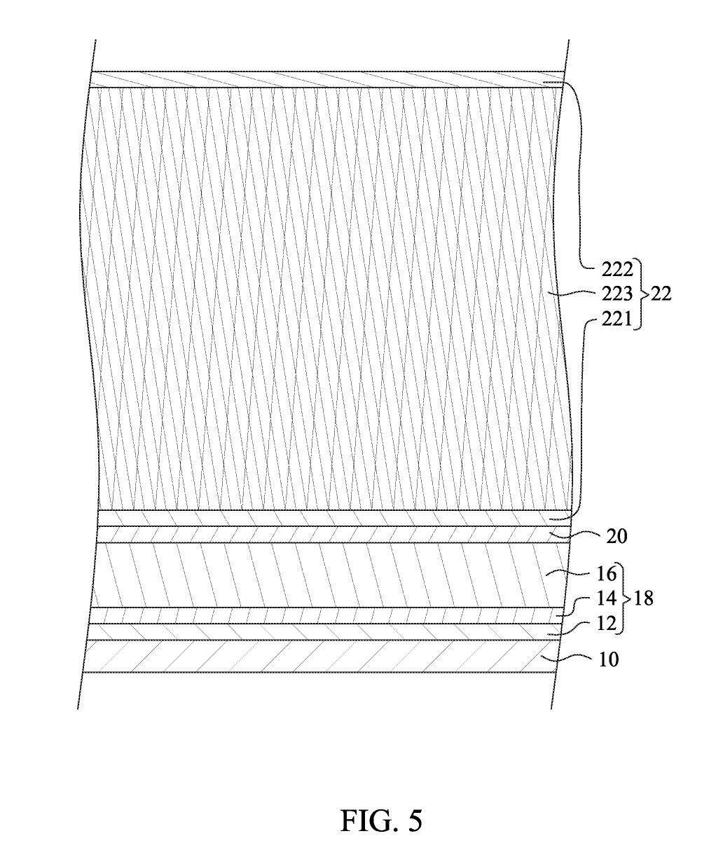

Referring to FIG. 5, an adhesion layer 20 is formed (for example, coated) on the third layer 16 of the resin surface layer 18. In this embodiment, the material of the adhesion layer 20 is a polyurethane (PU) binding agent, a polyvinyl chloride (PVC) binding agent, an ethylene vinyl acetate (EVA) copolymer binding agent, a hot melt adhesive, or a mixture thereof, and the solid content of the adhesion layer 20 is greater than 10 wt. %.

The adhesion layer 20 is continuously formed (for example, coated) on the third layer 16 of the resin surface layer 18, and an amount of coating thereof is 205.5 g/m². In this embodiment, the amount of coating the adhesion layer 20 is approximately equal to that of the polyether-polyurethane solution.

Subsequently, a three-dimensional (3D) fabric 22 is attached to the adhesion layer 20, where the 3D fabric 22 includes a plurality of arranged fibers 223, so as to form an air permeable structure. In this embodiment, the 3D fabric 22 is continuously attached to the adhesion layer 20, so as to form a continuous production. In this embodiment, the thickness of the 3D fabric 22 ranges from 2.0 mm to 20 mm.

In this embodiment, the 3D fabric 22 is a sandwich fabric, which further includes a top layer 221 and a bottom layer 222. The fibers 223 are sandwiched between the top layer 221 and the bottom layer 222, and the top layer 221 of the 3D fabric 22 is attached to the adhesion layer 20. In an embodiment, the top layer 221 and the bottom layer 222 are weaving layers, one ends of the fibers 223 are in contact with the top layer 221, and the other ends of the fibers 223 are in contact with the bottom layer 222. In the 3D fabric 22, the fibers 223 are arranged or woven into a specific pattern. In an embodiment, one end of each of the fibers 223 is in contact with the top layer 221, the other end of each of the fibers 223 is in contact with the bottom layer 222, and the fibers 223 are parallel with each other or are slightly staggered with each other. As show in FIG. 5, the space between the fibers 223 are air permeable passages, and the fibers 223 can substain a vertical external force and provide a cushion in a vertical direction.

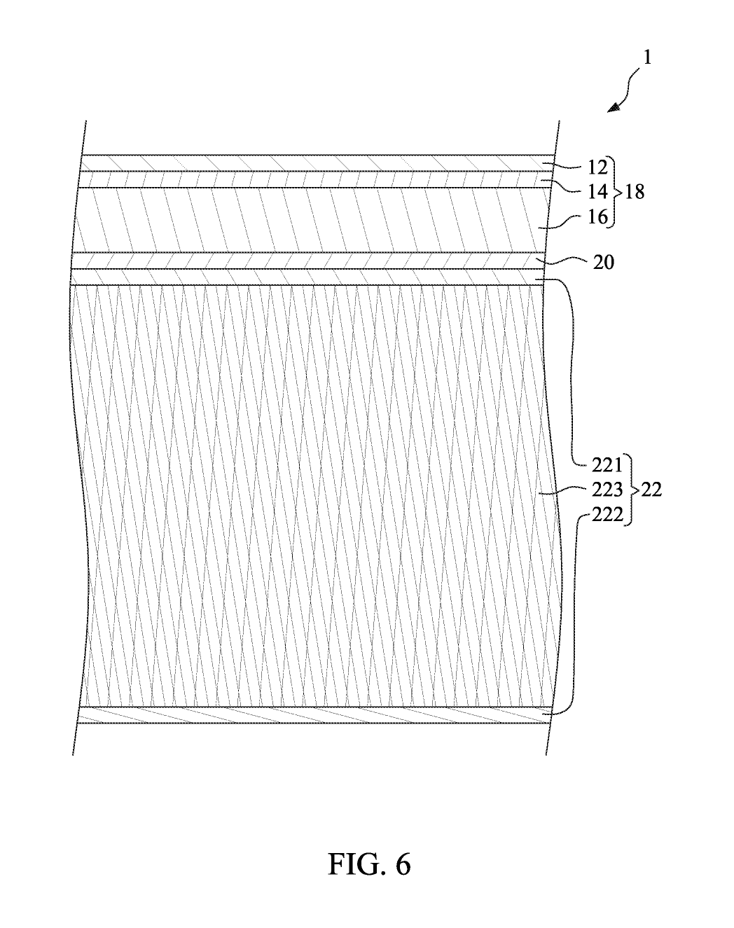

Referring to FIG. 6, the release paper 10 is removed, so as to obtain a laminated composite material 1. In this embodiment, the release paper 10 is continuously separated from the resin surface layer 18, and the laminated composite material 1 can be continuously rolled up. In this embodiment, the laminated composite material 1 may be directly used as a cladding material used to clad, for example, a vehicle seat or other hard body. In other words, in this embodiment, it is unnecessary to further adhere a fabric layer and a foam material. As compared with the prior art, the making method of this embodiment is more simple, and there are fewer layers, resulting in relatively lower manufacturing costs.

FIG. 6 illustrates a schematic cross-sectional diagram of a laminated composite material 1 according to an embodiment the present invention. The laminated composite material 1 includes a 3D fabric 22, an adhesion layer 20 and a resin surface layer 18. The 3D fabric 22 includes a plurality of arranged fibers 223 to form an air permeable structure. In this embodiment, the thickness of the 3D fabric 22 ranges from 2.0 mm to 20 mm. In this embodiment, the 3D fabric 22 is a sandwich fabric, which further includes a top layer 221 and a bottom layer 222. The fibers 223 are sandwiched between the top layer 221 and the bottom layer 222. In an embodiment, the top layer 221 and the bottom layer 222 are weaving layers, one ends of the fibers 223 are in contact with the top layer 221, and the other ends of the fibers 223 are in contact with the bottom layer 222. In the 3D fabric 22, the fibers 223 are arranged or woven into a specific pattern. In an embodiment, one end of each of the fibers 223 is in contact with the top layer 221, the other end of each of the fibers 223 is in contact with the bottom layer 222, and the fibers 223 are parallel with each other or are slightly staggered with each other. As show in FIG. 6, the space between the fibers 223 are air permeable passages, and the fibers 223 can substain a vertical external force and provide a cushion in a vertical direction.

The adhesion layer 20 is disposed on a surface of the top layer 221 of the 3D fabric 22. In this embodiment, the material of the adhesion layer 20 is a polyurethane (PU) binding agent, a polyvinyl chloride (PVC) binding agent, an ethylene vinyl acetate (EVA) copolymer binding agent, a hot melt adhesive, or a mixture thereof.

The resin surface layer 18 is disposed on the adhesion layer 20. The resin surface layer 18 includes at least one layer formed by curing a polyurethane (PU) solution. That is, the resin surface layer 18 is adhered to the 3D fabric 22 through the adhesion layer 20. In this embodiment, the resin surface layer 18 includes a first layer 12, a second layer 14 and a third layer 16. The third layer 16 is disposed on the adhesion layer 20, and the third layer 16 is formed by curing a polyurethane (PU) solution. In this embodiment, the solid content of the PU solution ranges from 80 wt. % to 95 wt. % and preferably, is about 90 wt. %, and the viscosity thereof ranges from 2000 cps to 10000 cps, and preferably, is 6000 cps. In this embodiment, the thickness of the third layer 16 ranges from 0.3 mm to 0.5 mm, and preferably, 0.35 mm to 0.4 mm. The third layer 16 is a main portion of the resin surface layer 18.

The second layer 14 is disposed on the third layer 16, and the second layer 14 is formed by curing a polyether-polyurethane solution. In this embodiment, the solid content of the polyether-polyurethane solution ranges from 10 wt. % to 20 wt. % and preferably, ranges from 12 wt. % to 13 wt. %, and the viscosity thereof ranges from 2000 cps to 3000 cps, and preferably, is 2500 cps. In this embodiment, the thickness of the second layer 14 ranges from 0.01 mm to 0.04 mm, and preferably, is 0.025 mm. In this embodiment, the thickness of the third layer 16 is 50 to 13 times the thickness of the second layer 14. The second layer 14 is used to adhere the first layer 12 and the third layer 16.

The first layer 12 is disposed on the second layer 14, and the first layer 12 is formed by curing a polycarbonate-polyurethane solution. In this embodiment, the solid content of the polycarbonate-polyurethane solution ranges from 10 wt. % to 20 wt. % and preferably, ranges from 12 wt. % to 13 wt. %, and the viscosity thereof ranges from 2000 cps to 3000 cps, and preferably, is 2500 cps. In this embodiment, the thickness of the first layer 12 ranges from 0.01 mm to 0.04 mm, and preferably, is 0.025 mm. In this embodiment, the thickness of the second layer 14 is equal to the thickness of the first layer 12. However, it could be understood that the thickness of the second layer 14 may be different from the thickness of the first layer 12. The first layer 12 has a greater antiwear property, and is used as an antiwear layer for protecting the laminated composite material 1.

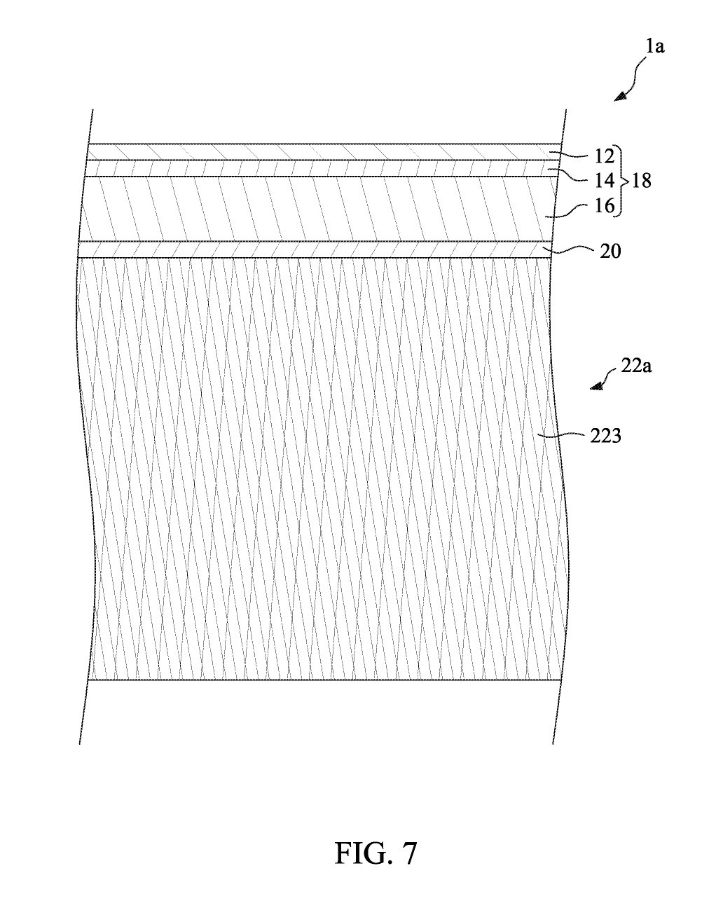

FIG. 7 illustrates a schematic cross-sectional diagram of a laminated composite material la according to an embodiment the present invention. The laminated composite material 1a of this embodiment is similar to the laminated composite material 1 as shown in FIG. 6, and the difference is described as follows. The 3D fabric 22a of the laminated composite material 1a of this embodiment only includes the fibers 223, and does not include the top layer 221 and the bottom layer 222. Therefore, in this embodiment, the adhesion layer 20 is directly disposed on a surface of the fibers 223 of the 3D fabric 22.

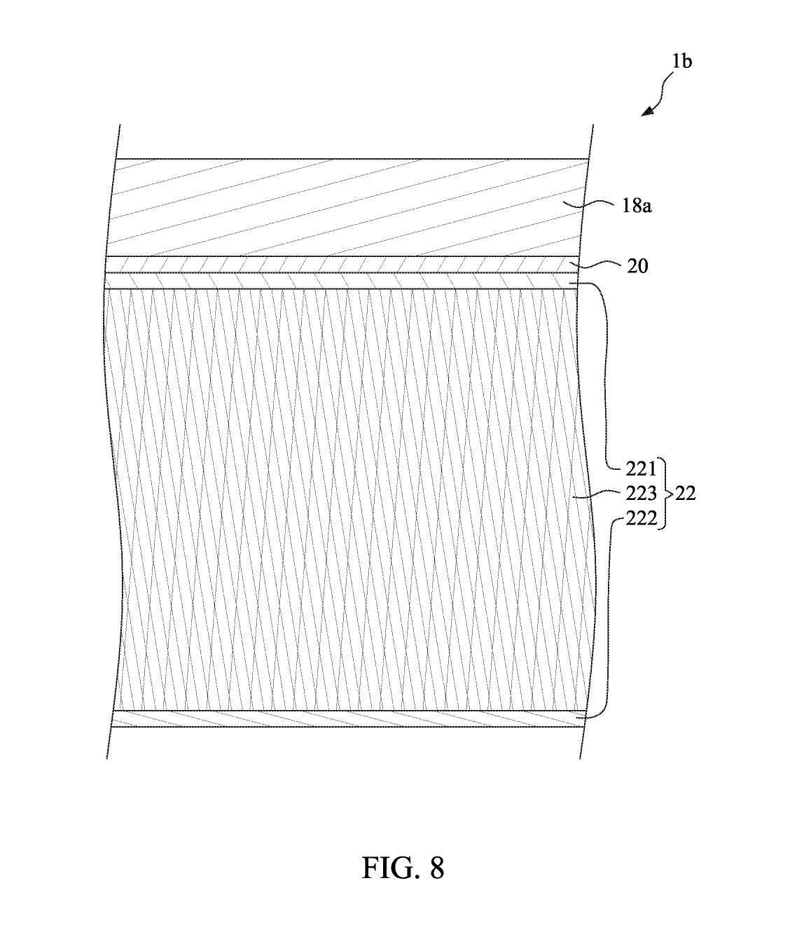

FIG. 8 illustrates a schematic cross-sectional diagram of a laminated composite material 1b according to an embodiment the present invention. The laminated composite material 1b of this embodiment is similar to the laminated composite material 1 as shown in FIG. 6, and the difference is described as follows. The resin surface layer 18a of the laminated composite material 1b of this embodiment is a single-layered structure rather than a three-layered structure. It is understood that the resin surface layer 18a may be a double-layered structure.

The above embodiments only describe the principle and the efficacies of the present invention, and are not used to limit the present invention. Therefore, modifications and variations of the embodiments made by persons skilled in the art do not depart from the spirit of the invention. The scope of the present invention should fall within the scope as defined in the appended claims.

What is claimed is:

1. A laminated composite material, comprising:
a 3D fabric including a plurality of arranged fibers to form an air permeable structure;
an adhesion layer disposed on a surface of the 3D fabric; and
a resin surface layer disposed on the adhesion layer, wherein the resin surface layer includes at least one layer formed by curing a polyurethane (PU) solution.

2. The laminated composite material according to claim 1, wherein the 3D fabric further includes a top layer and a bottom layer, the fibers are sandwiched between the top layer and the bottom layer, and the adhesion layer is disposed on the top layer of the 3D fabric.

3. The laminated composite material according to claim 2, wherein one end of the fibers contact the top layer, and the other end of the fibers contact the bottom layer.

4. The laminated composite material according to claim 1, wherein the resin surface layer includes a first layer, a second layer and a third layer, the first layer is cured from a polycarbonate-polyurethane solution, the second layer is cured from a polyether-polyurethane solution, the third layer is cured from a polyurethane (PU) solution, the third layer is disposed on the adhesion layer, the second layer is disposed on the third layer, and the first layer is disposed on the second layer.

5. The laminated composite material according to claim 4, wherein a solid content of the polycarbonate-polyurethane solution of the first layer ranges from 10 wt. % to 20 wt. %, a solid content of the polyether-polyurethane solution of the second layer ranges from 10 wt. % to 20 wt. %, and a solid content of the polyurethane (PU) solution of the third layer ranges from 80 wt. % to 95 wt. %.

6. A method for making a laminated composite material, comprising:
(a) providing a release paper;
(b) forming a resin surface layer on the release paper, where the resin surface layer includes at least one polyurethane (PU) solution;
(c) forming an adhesion layer on the resin surface layer; and
(d) attaching a 3D fabric to the adhesion layer, wherein the 3D fabric includes a plurality of arranged fibers, so as to form an air permeable structure.

7. The method according to claim 6, wherein in step (a), the release paper is continuously fed; in step (b), resin surface layer is continuously formed; in step (c), the adhesion layer is continuously formed; in step (d), the 3D fabric is continuously attached to the adhesion layer, so as to form a continuous production.

8. The method according to claim 6, wherein step (b) comprises:
(b1) coating a polycarbonate-polyurethane solution on the release paper;
(b2) drying the polycarbonate-polyurethane solution to form a first layer;
(b3) coating a polyether-polyurethane solution on the first layer;
(b4) drying the polyether-polyurethane solution to form a second layer;
(b5) coating a polyurethane (PU) solution on the second layer; and
(b6) drying the polyurethane (PU) solution to form a third layer, wherein the first layer, the second layer and the third layer form the resin surface layer.

9. The method according to claim 8, wherein in step (b1), a solid content of the polycarbonate-polyurethane solution ranges from 10 wt. % to 20 wt. %; in step (b3), a solid content of the polyether-polyurethane solution ranges from 10 wt. % to 20 wt. %; and in step (b5), a solid content of the polyurethane (PU) solution ranges from 80 wt. % to 95 wt. %.

10. The method according to claim 6, wherein in step (d), the 3D fabric further includes a top layer and a bottom layer, the fibers are sandwiched between the top layer and the bottom layer, and the top layer of the 3D fabric is attached to the adhesion layer.
